(19) United States
(12) Patent Application Publication
(10) Pub. No.: US 2026/0084567 A1
(43) Pub. Date: Mar. 26, 2026

(54) METHOD FOR SWITCHING BETWEEN FAST CHARGING MODES

(71) Applicants: Hyundai Motor Company, Seoul (KR); Kia Corporation, Seoul (KR)

(72) Inventors: Young-Chan Byun, Hwaseong-si (KR); Joong-Woo Lee, Hwaseong-si (KR)

(21) Appl. No.: 19/201,310

(22) Filed: May 7, 2025

(30) Foreign Application Priority Data
Sep. 25, 2024 (KR) 10-2024-0129878

(51) Int. Cl. B60L 53/62; B60L 53/10; B60L 53/22; B60L 53/65; B60L 53/66

(52) U.S. Cl. CPC B60L 53/62; B60L 53/11; B60L 53/22; B60L 53/65; B60L 53/66; B60L 2210/14; B60L 2240/547

(57) ABSTRACT

Provided is a method for switching between fast charging modes capable of changing the fast charging mode after determining an initial charging mode by considering a vehicle high-voltage battery current voltage and a charger output voltage The method includes exchanging information between a charger and a vehicle, comparing a high-voltage battery maximum voltage and a charger maximum output voltage by a charge controller of the vehicle according to the exchange of the information, comparing a high-voltage battery current voltage and the charger maximum output voltage by the charge controller when the high-voltage battery maximum voltage is greater than the charger maximum output voltage, and entering the charge controller into a boost charging mode when the high-voltage battery current voltage is greater than the charger maximum output voltage.

### CROSS-REFERENCE TO RELATED APPLICATIONS

This application claims priority to Korean Patent Application No. 10-2024-0129878, filed on Sep. 25, 2024, which is incorporated herein by reference in its entirety.

### TECHNICAL FIELD

The present disclosure relates to a charging technology, and more particularly, to a method for switching between fast charging modes in a multi-charging vehicle.

### BACKGROUND

In the case of a vehicle boost charging system, there are a non-insulated structure boost charging system that boosts voltage by utilizing a vehicle motor/inverter, and insulated structure boost charging systems that utilize a separate converter.

Typically, a vehicle that uses this boost charging system has two fast charging modes such as a boost charging mode and a direct charging mode. This is called multi-charging.

In a vehicle, when a high-voltage battery maximum voltage is greater than a charger maximum voltage, the vehicle enters a boost charging mode and boosts the voltage to charge a high-voltage battery. Conversely, when the vehicle high-voltage battery maximum voltage is smaller than the charger maximum voltage, the vehicle enters the direct charging mode and charges the high-voltage battery.

In general, in a vehicle with a high-voltage battery of 500 V or more, the fast charging mode is determined as boost charging mode or direct charging mode by comparing information on the high-voltage battery maximum voltage and information on the charger maximum output voltage at the beginning of charging. Based on this determination, the charging mode is not changed until the charging is completed after entering the charging.

Therefore, when entering the boost charging mode, there is an advantage in that charging is possible even when the charger maximum output voltage is lower than the high-voltage battery maximum voltage. However, there is a problem in that the overall charging efficiency and performance are lowered due to the power consumed because the boost converter switches for voltage boosting during the entire charging period.

In addition, during a section where the high-voltage battery current voltage is smaller than the charger maximum output voltage, direct charging is possible instead of boost charging. However, when entering fast charging, only the information on the charger maximum output voltage and the information on the high-voltage battery maximum voltage are used to determine the charging mode. As a result, the boost charging mode is operated even in the section, and there is a problem that the charging efficiency and/or performance are lowered due to the power consumed by switching for voltage boosting.

Meanwhile, when the fast charging enters the direct charging mode, there is an advantage of improved charging efficiency and/or performance because there is no switching operation for voltage boosting in the boost converter compared to boost charging. However, when the voltage cannot be increased on the charger side due to problems with the circuit/control of the charger, the vehicle high-voltage battery voltage and the charger voltage remain the same. In this case, the charging can no longer proceed and is terminated.

### SUMMARY

The present disclosure has been proposed to solve the problems according to the above background technology, and an object of the present disclosure is to provide a method for switching between fast charging modes capable of changing the fast charging mode after determining an initial charging mode by considering a vehicle high-voltage battery current voltage and a charger output voltage.

In addition, another object of the present disclosure is to provide a method for switching between fast charging modes capable of securing charging robustness by changing the fast charging mode depending on situations.

In addition, still another object of the present disclosure is to provide a method for switching between fast charging modes capable of improving charging performance and/or efficiency by reducing voltage boosting switching of a boost converter.

In order to achieve the objects presented above, the present disclosure provides a method for switching between fast charging modes capable of changing the fast charging mode after determining an initial charging mode by considering a vehicle high-voltage battery current voltage and a charger output voltage.

The method includes: exchanging information between a charger and a vehicle; comparing a high-voltage battery maximum voltage and a charger maximum output voltage by a charge controller of the vehicle according to the exchange of the information; comparing a high-voltage battery current voltage and the charger maximum output voltage by the charge controller when the high-voltage battery maximum voltage is greater than the charger maximum output voltage; entering the charge controller into a boost charging mode when the high-voltage battery current voltage is greater than the charger maximum output voltage; and entering the charge controller into a direct charging mode when the high-voltage battery current voltage is equal to or less than the charger maximum output voltage.

The method may further include entering the charge controller into the direct charging mode to compare the high-voltage battery current voltage and a charger actual output voltage and maintain the direct charging mode or change the direct charging mode to the boost charging mode according to a result of the comparison when the high-voltage battery maximum voltage is equal to or less than the charger maximum output voltage.

The changing may include changing the direct charging mode to the boost charging mode using a vehicle current command transmitted to the charger and a charger output current from the charger by the charge controller when the high-voltage battery current voltage is equal to or more than the charger actual output voltage.

The changing of the direct charging mode to the boost charging mode may include setting the vehicle current command to a charger minimum supply current by the charge controller, comparing whether the vehicle current command and the charger output current are the same by the charge controller, and changing the direct charging mode to the boost charging mode when the vehicle current command and the charger output current are the same as a result of the comparison.

The changing of the direct charging mode to the boost charging mode may include increasing the vehicle current command to an original value after the charge controller changes the direct charging mode to the boost charging mode.

The vehicle current command may be set to a preset current when information on a charger minimum supply current is not provided.

The changing may include maintaining the direct charging mode by the charge controller when the high-voltage battery current voltage is smaller than the charger actual output voltage.

The entering of the direct charging mode may include comparing the high-voltage battery current voltage and a pre-calculated limit voltage by the charge controller to maintain the direct charging mode or change the direct charging mode to the boost charging mode according to a result of the comparison.

The changing may include changing the direct changing mode to the boost charging mode using a vehicle current command and a charger output current from the charger by the charger controller when the high-voltage battery current voltage is equal to or more than the limit voltage.

In this case, the limit voltage may be a product of the charger maximum output voltage and a certain ratio.

The changing may include maintaining the direct charging mode by the charge controller when the high-voltage battery current voltage is smaller than the limit voltage.

In the entering of the boost charging mode in a state where the high-voltage battery current voltage is greater than the charger maximum output voltage, the boost charging mode may be maintained until the charging ends.

The boost charging mode may be executed using a separate boost converter installed in the vehicle or a drive block including a motor and inverter in the vehicle.

In the entering of the direct charging mode, a charging initial entry mode may be the direct charging mode.

According to the present disclosure, compared to a method of determining the boost charging mode or the direct charging mode by comparing only the vehicle high-voltage battery maximum voltage and the charger maximum output voltage, by changing the charging mode after determining an initial charging mode by considering the vehicle high-voltage battery current voltage and the charger output voltage, it is possible to improve charging performance and/or charging robustness.

In addition, according to the present disclosure, the vehicle can be fully charged by switching from the direct charging mode to the boost charging mode even when charging is impossible because the charger output voltage does not rise higher than the vehicle high-voltage battery current voltage due to a problem in the circuit/control of the charger or the like, and thus, it is possible to improve the charging robustness.

In addition, according to the present disclosure, in a case where the vehicle high-voltage battery maximum voltage>the charger maximum voltage>the vehicle high-voltage battery current voltage, when the direct charging mode is switched to the boost charging mode after the vehicle is operated in the direct charging mode until boost charging is possible, voltage boosting switching of the boost converter can be reduced, and thus, it is possible to improve the charging performance/efficiency.

### BRIEF DESCRIPTION OF THE DRAWINGS

FIG. 1 is a conceptual diagram of a vehicle charging system according to one embodiment of the present disclosure.

FIG. 2A is a detailed block diagram of an insulated structure boost charging method implemented in a vehicle illustrated in FIG. 1.

FIG. 2B is a detailed block diagram of a non-insulated structure boost charging method implemented in the vehicle illustrated in FIG. 1.

FIG. 3 is a diagram illustrating a concept in which a charge controller configured in FIG. 2A or FIG. 2B determines an initial charge entry mode and a final charge switching mode.

FIGS. 4A and 4B are flowcharts illustrating a process of switching between fast charging modes according to one embodiment of the present disclosure.

FIG. 5 is a conceptual diagram of the switching between fast charging modes when a vehicle high-voltage battery maximum voltage<a charger maximum output voltage according to one embodiment of the present disclosure.

FIG. 6 is a conceptual diagram of the switching between fast charging modes when the vehicle high-voltage battery maximum voltage>the charger maximum output voltage according to one embodiment of the present disclosure.

FIG. 7 is a conceptual diagram of boost charging according to one embodiment of the present disclosure.

FIG. 8 is a conceptual diagram of serial charging according to one embodiment of the present disclosure.

### DETAILED DESCRIPTION OF ILLUSTRATIVE EMBODIMENTS

The above-mentioned objects, features and advantages are described in detail below with reference to the attached drawings, and thus, those with ordinary knowledge in the technical field to which the present disclosure pertains can easily practice the technical idea of the present disclosure. In explaining the present disclosure, when it is judged that a detailed description of a known technology related to the present disclosure may unnecessarily obscure the gist of the present disclosure, a detailed description thereof will be omitted.

Hereinafter, preferred embodiments of the present disclosure will be described in detail with reference to the attached drawings. In the drawings, the same reference numerals are used to indicate the same or similar components.

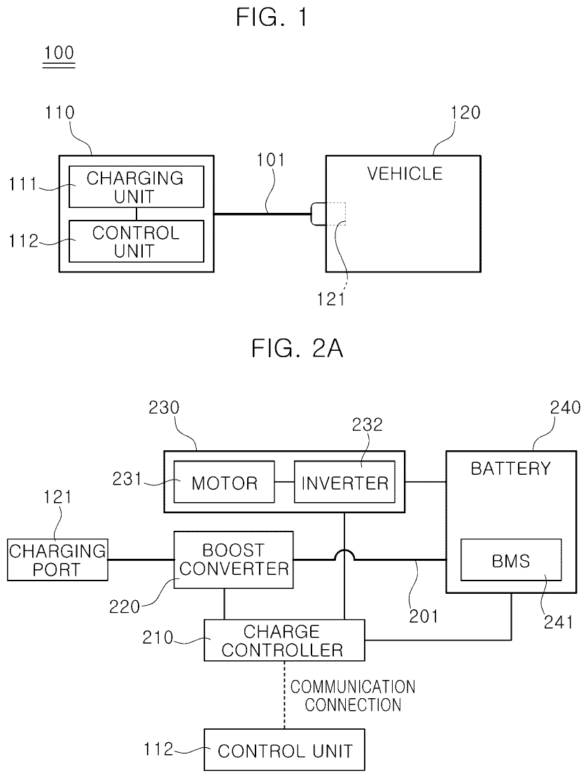

FIG. 1 is a conceptual diagram of a vehicle charging system 100 according to one embodiment of the present disclosure. Referring to FIG. 1, the vehicle charging system 100 includes a charger 110 that supplies charging power, a vehicle 120 that receives the charging power from the charger 110, or the like. The charger 110 may be configured with a connection connector 101, and charging may be performed by connecting this connection connector 101 to a charging port 121 of the vehicle 120.

The charger 110 may be an electric vehicle supply equipment (EVSE)). The charger 110 may be configured to include a charging unit 111 that generates charging power, particularly DC charging power, a control unit 112 that controls the charging unit 111 and performs a communication connection with a vehicle 120, or the like.

The charging unit 111 performs the function of receiving AC power, converting the AC power into DC charging power, and supplying the DC charging power to the vehicle 120. To this end, the charging unit 11 may include a circuit such as an alternating current-direct current (AC-DC) converter and a regulator, and a program for control.

The control unit 112 controls the charging unit 111 and performs a function of performing a communication connection with the vehicle 120 and/or an external network. To this end, the control unit 112 may include a microprocessor, a microcomputer, a communication circuit, a memory, a display, an input means, or the like. The display may be a touch screen, or the like. Therefore, both an input means and an output means are possible. The input means may be a button, a microphone, or the like.

The vehicle 120 includes the charging port 121 that is connected to the connection connector 101 of the charger 110. Accordingly, the connection connector 101 and the charging port 121 may be configured using any one of a CCS1 (Combined Charging System 1) method, a CCS2 (Combined Charging System 2) method, and an NACS (North American Charging Standard) method.

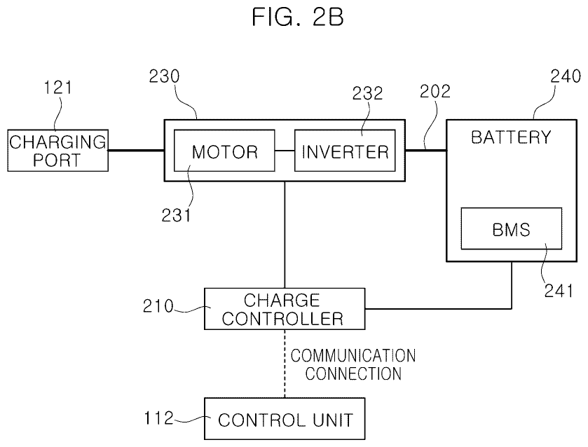

FIG. 2A is a detailed block diagram of an insulated structure boost charging method implemented in the vehicle 120 illustrated in FIG. 1. Referring to FIG. 2A, the vehicle 120 may include a charge controller 210, a boost converter 220, a drive block 230, a battery 240, or the like. Here, the insulated structure boost charging method refers to a method of boosting using a separate boost converter 220.

The charge controller 210 is connected to communication with the control unit 112 of the charger 110, and the charger 110 is connected to communication with the charge controller 210 through a control pilot (CP) line. Accordingly, the charge controller 210 and the control unit 112 send and receive data related to fast charging by carrying PLC communication on a CP signal for fast charging.

In addition, the charge controller 210 performs a function of controlling the components, namely, the boost converter 220, the drive block 230, and the battery 240. In particular, the charge controller 210 determines an initial charge mode by considering the high-voltage battery current voltage and the charger output voltage, and performs a control algorithm for switching between fast charging modes. To this end, the charge controller 210 may include a microcomputer, a microprocessor, an electronic circuit, a communication circuit, a memory, and the like.

The memory may include a combination of nonvolatile memory such as a flash memory disk (SSD: Solid State Disk), a hard disk drive, flash memory, an electrically erasable programmable read-only memory (EEPROM), a Static RAM (SRAM), a Ferro-electric RAM (FRAM), a Phase-change RAM (PRAM), and a Magnetic RAM (MRAM), and/or volatile memory such as a Dynamic Random Access Memory (DRAM), a Synchronous Dynamic Random Access Memory (SDRAM), and a Double Data Rate-SDRAM (DDR-SDRAM).

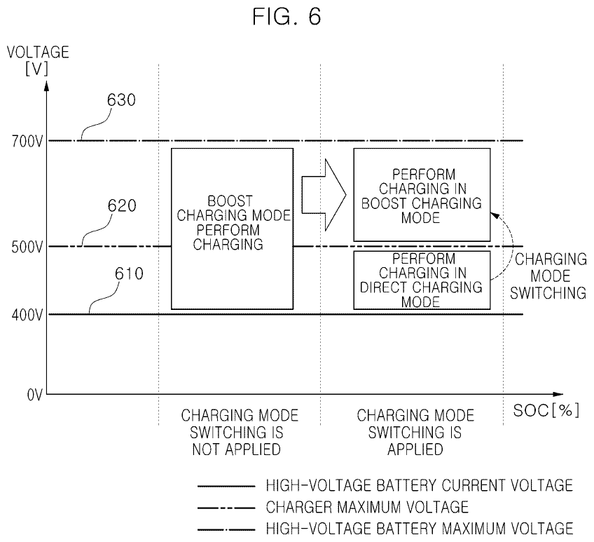

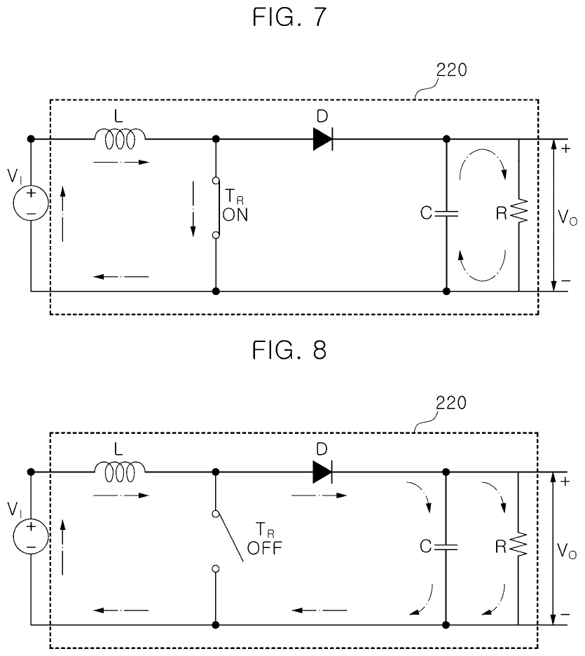

The boost converter 220 is configured separately in the vehicle, and performs switching for voltage boosting. For this purpose, a switching element, an inductor, a diode, a capacitor, a resistor, and the like may be configured, which are illustrated in FIGS. 7 and 8. This will be described later.

The boost converter 220 forms a charging path 201 from the charger 110 to the battery 240 through the charging port 121. That is, a first charging path 201 is formed in the order of the charging port 121, the boost converter 220, and the battery 240. Boost charging or direct charging is performed through this charging path 201. The boost charging is performed by boosting the voltage through the boost converter 220, and for example, about 400 V power supplied from the charger 110 may be boosted to about 800 V power and supplied to the battery 240.

The direct charging is a form in which the switching element in the boost converter 220 is kept in the off state and the charger 110 and the battery 240 are directly connected without boosting the voltage.

The drive block 230 includes a motor 231 and an inverter 232 for operating the motor 231. The motor 120 is mainly a three-phase alternating current (AC) motor. The inverter 232 performs the function of converting DC power from the battery 240 into AC power and supplying the converted AC power to the motor 120.

In FIG. 2A, the motor 231 and the inverter 232 are illustrated separately, but they may be integrated and configured as one. That is, the inverter 232 may be integrated into the motor 231.

The battery 240 includes battery cells (not illustrated) in series and/or in parallel, and the battery cells may be a high-voltage battery cell for an electric vehicle, such as a nickel metal battery cell, a lithium ion battery cell, a lithium polymer battery cell, a lithium sulfur battery cell, a sodium sulfur battery cell, and an all-solid-state battery cell. In general, the high-voltage battery is a battery used as a power source for moving an electric vehicle and refers to a high voltage of 100 V or higher. However, it is not limited thereto, and a low-voltage battery is also possible.

The battery 240 may include a battery management system (BMS) 241. The BMS 241 optimizes battery management for an electric vehicle to increase energy efficiency and extend the lifespan. The BMS 241 monitors voltage, current, and temperature of the battery in real time and prevents excessive charging and discharging in advance to increase battery safety and reliability.

FIG. 2B is a detailed block diagram of a non-insulated structure boost charging method implemented in the vehicle illustrated in FIG. 1. Referring to FIG. 2b, the vehicle 120 may include the charge controller 210, the drive block 230, the battery 240, or the like. Here, the non-insulated structure boost charging method refers to a method of boosting by using the drive block 230 including the motor 231 and the inverter 232 without using the separate boost converter 220.

Accordingly, a second charging path 202 is formed in the order of the charging port 121, the drive block 230, and the battery 240.

The boost charging or direct charging is performed through this charging path 202. The boost charging is performed by boosting the voltage through the drive block 230. For example, about 400 V power supplied from the charger 110 is boosted to about 800 V power and supplied to the battery 240.

The direct charging is a form in which the switching element in the boost converter 220 is kept in the off state and the charger 110 and the battery 240 are directly connected without boosting the voltage.

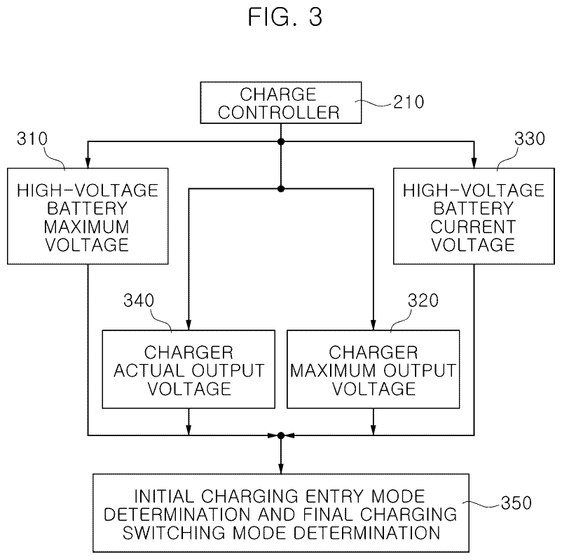

FIG. 3 is a diagram illustrating a concept in which the charge controller 210 configured in FIG. 2A or FIG. 2B determines an initial charge entry mode and a final charge switching mode. Referring to FIG. 3, the charge controller 210 may utilize a total of four types of power information of: 1) a high-voltage battery maximum voltage 310, 2) a charger maximum output voltage 320, 3) a high-voltage battery current voltage 330, and 4) a charger actual output voltage 340.

1) The high-voltage battery maximum voltage 310 refers to the maximum voltage at which the battery 240 can be charged.

2) The charger maximum output voltage 320 refers to the maximum chargeable voltage provided by the charger 110 side.

3) The high-voltage battery current voltage 330 refers to the voltage at which the battery 240 is currently being charged.

4) The charger actual output voltage 340 refers to the actual voltage output by the charger during charging. The charger actual output voltage 340 may be provided in real time from the charger 110 side to the vehicle 120 side, or may be generated using a voltage sensor (not illustrated) on the charger 110 side.

Using these four pieces of information, the fast charging mode is determined, the initial charging entry mode is determined, and the final charging switching mode is determined 350. This can be explained in an easy-to-understand manner as follows.

a) High-voltage battery maximum voltage 310<charger maximum output voltage 320

The charge controller 210 enters the direct charging mode as an initial charge mode.

Meanwhile, when a situation occurs in which charging does not occur because the charger actual output voltage 340 is not formed higher than the high-voltage battery current voltage 330 due to a circuit/control problem or the like occurring in the charger 110 during fast charging in the direct charging mode, the direct charging mode is changed to the boost charging mode.

b) When the high-voltage battery maximum voltage 310>charger maximum output voltage 320, the charge controller 210 enters the boost charging mode as the final charging mode.

The charger maximum output voltage 320 and the high-voltage battery current voltage 310 are compared to determine which charging mode to enter.

b-1) When the charger maximum output voltage 320>the high-voltage battery current voltage 330, the charge controller 210 enters the direct charging mode.

When the battery 240 is charged and the voltage rises to a limit voltage (that is, the charger maximum output voltage x a certain ratio), the direct charging mode is changed to the boost charging mode by the charge controller 210.

b-2) When the charger maximum output voltage 320<the high-voltage battery current voltage 330, the charge controller 210 enters the boost charging mode.

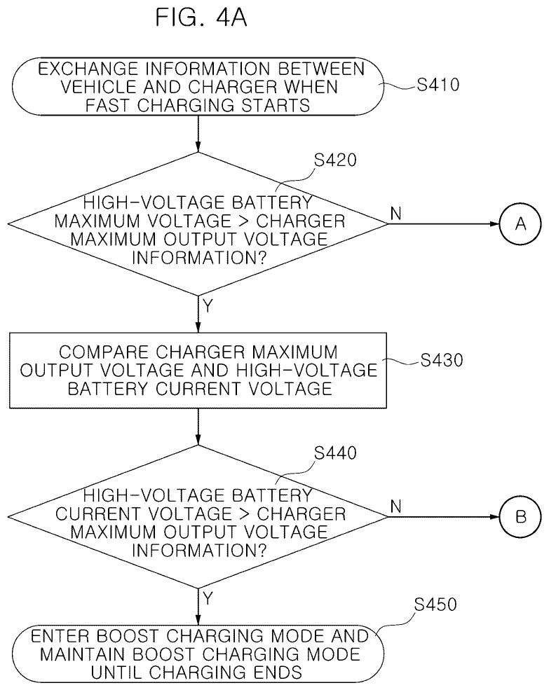

FIGS. 4A and 4B are flowcharts illustrating a process of switching between fast charging modes according to one embodiment of the present disclosure. As schematically explained in FIGS. 4A and 4B, when the high-voltage battery maximum voltage 310>the charger maximum output voltage 320, it is determined whether to enter the boost charging mode. In addition, when the high-voltage battery maximum voltage 310<the charger maximum output voltage 320, it is determined whether to enter the direct charging mode.

First, referring to FIG. 4A, when the charger 110 and the vehicle 120 are connected and the fast charging starts, information is exchanged between the control unit 112 of the charger 110 and the charge controller 210 of the vehicle 120 (Step S410). In detail, the control unit 112 transmits charger-related information to the charge controller 210, and the charge controller 210 transmits battery-related information to the control unit 112 of the charger 110.

The charger-related information may include information such as charger maximum output voltage, charger actual output voltage, charger output current, charger minimum supply current, power, and Mac address. The battery-related information may include high-voltage battery maximum voltage, high-voltage battery current voltage, and State of Charge (SOC). Here, the SOC may also mean a charge amount.

Thereafter, the charge controller 210 compares the high-voltage battery maximum voltage 310 and the charger maximum output voltage 320 based on the information exchange to confirm whether the high-voltage battery maximum voltage 310 is greater than the charger maximum output voltage 320 (Step S420).

In Step S420, when the high-voltage battery maximum voltage 310 is greater than the charger maximum output voltage 320, the charge controller 210 compares the high-voltage battery current voltage 330 and the charger maximum output voltage 320 to confirm whether the high-voltage battery current voltage 330 is greater than the charger maximum output voltage 320 (Steps S430 and S440).

In other words, even when the high-voltage battery maximum voltage 310>the charger maximum output voltage 320, the charging mode does not immediately enter the boost charging mode, but the charger maximum output voltage 320 and the high-voltage battery current voltage 330 are compared to determine whether to enter the initial charging mode.

In Step S440, as a result of the comparison, when the high-voltage battery current voltage 330 is greater than the charger maximum output voltage 320, the charge controller 210 enters the boost charging mode and maintains this boost charging mode until the charging ends (Step S450).

At this time, the boost charging mode may be executed by using the separate boost converter 220 in a vehicle equipped with the boost converter 220. Of course, in a vehicle not equipped with the separate boost converter 220, the boost charging mode may be executed by using the drive block 230 including the motor 231 and the inverter 232.

Meanwhile, in the case of the boost charging mode, there may be a section where the high-voltage battery current voltage 330 is lower than the charger maximum output voltage 320, and in the corresponding section, the direct charging mode can be entered. When the corresponding section proceeds in the boost charging mode, the boost converter 220 or the drive block 230 performs switching for voltage boosting.

However, the overall charging efficiency and performance are lowered due to the power consumed. When the charging proceeds in the direct charging mode in the corresponding section, charging performance and/or efficiency may be improved compared to the existing charging performance and/or efficiency.

Referring to FIG. 4B, in Step S420 of FIG. 4A, when the high-voltage battery maximum voltage 310 is lower than or equal to the charger maximum output voltage 320, the charge controller 210 enters the direct charging mode Step (S421).

In the direct charging mode, charging power is supplied directly from the charger 110 to the battery 240 without a boosting process, thereby performing charging. In the case of the direct charging mode, since there is no switching operation for voltage boosting in the boost converter 220 or the drive block 230 compared to the boosting charging mode, there is an advantage of improved charging efficiency and/or charging performance.

However, when the voltage cannot be increased on the charger side due to a problem with the circuit/control of the charger 110, the high-voltage battery voltage of the vehicle 120 and the charger voltage remain the same, so charging can no longer proceed and may be terminated.

In such a case, when changing from the direct charging mode to the boost charging mode, the vehicle can be fully charged without charging being terminated by boosting the voltage in the boost converter 220 or drive block 230.

To explain in an easy-to-understand manner, when the charger voltage does not rise higher than the high-voltage battery voltage due to a problem with the circuit/control of the charger 110 by utilizing the charger-related information provided by the charger 110 side while the direct charging mode is executed, the charging in the vehicle is not terminated.

The fast charging mode is switched from the direct charging mode to the boost charging mode, and the voltage is boosted in the boost converter 220 or drive block 230 to fully charge the battery 240.

Referring to FIG. 4B, the charge controller 210 confirms whether the high-voltage battery current voltage 330 is equal to or more than the charger actual output voltage 340 (Step S460).

In Step S460, as a result of the confirmation, when the high-voltage battery current voltage 330 is equal to or more than the charger actual output voltage 340, the charge controller 210 sets the vehicle current command to the charger minimum supply current (Step S471).

In other words, this setting is to lower the charging current command to the charger minimum supply current so that no problem occurs during the charging mode switching process, and to switch the charging mode at the lowest charging current state that the charger can supply. When information on the charger minimum supply current is not provided, the charge controller 210 sets the vehicle current command to a preset current (for example, 0 A).

Thereafter, the charge controller 210 compares and confirms the vehicle current command transmitted to the charger 110 with the charger output current from the charger 110 (Step S480). In other words, the charger controller confirms whether the vehicle current command is the same as or similar to the charger output current. That is, it has a certain error range. For example, the error range may be about +5%.

In Step S480, when the vehicle current command is almost the same as the charger output current, the charge controller 210 changes the direct charging mode to the boost charging mode and enters the boost charging mode (Step S490).

In contrast, in Step S480, when the vehicle current command is not equal to the charger output current, Steps S471 to S480 are performed again.

Meanwhile, in Step S460, when the high-voltage battery current voltage 330 is less than the charger actual output voltage 340, Step S421 is performed again. That is, the charge controller 210 maintains the direct charging mode.

Referring to FIG. 4B, in Step S440 of FIG. 4A, when the high-voltage battery current voltage 330 is equal to or less than the charger actual output voltage 340, the charge controller 210 enters the direct charging mode (Step S441).

Thereafter, the charge controller 210 compares the high-voltage battery current voltage 330 and a limit voltage (Step S470). Here, the limit voltage may be calculated as the charger maximum output voltage x a certain ratio in advance.

In Step S470, as a result of the confirmation, when the high-voltage battery current voltage 330 is equal to or more than the limit voltage, the charge controller 210 sets the vehicle current command to the charger minimum supply current (Step S471).

Thereafter, the charge controller 210 compares and confirms the vehicle current command and the charger output current from the charger 110 (Step S480).

In Step S480, when the vehicle current command is almost the same as the charger output current, the charge controller 210 changes the direct charging mode to the boost charging mode and enters the boost charging mode (Step S490). In detail, when the high-voltage battery current voltage 330 is charged and the voltage increases to the charger maximum output voltage x a certain ratio, the charge controller 210 switches from the direct charging mode to the boost charging mode.

In contrast, in Step S480, when the vehicle current command is not equal to the charger output current, Steps S471 to S480 are performed again.

Meanwhile, in Step S470, when the high-voltage battery current voltage 330 is smaller than the limit voltage, Step S441 is performed again. That is, the charge controller 210 maintains the direct charging mode.

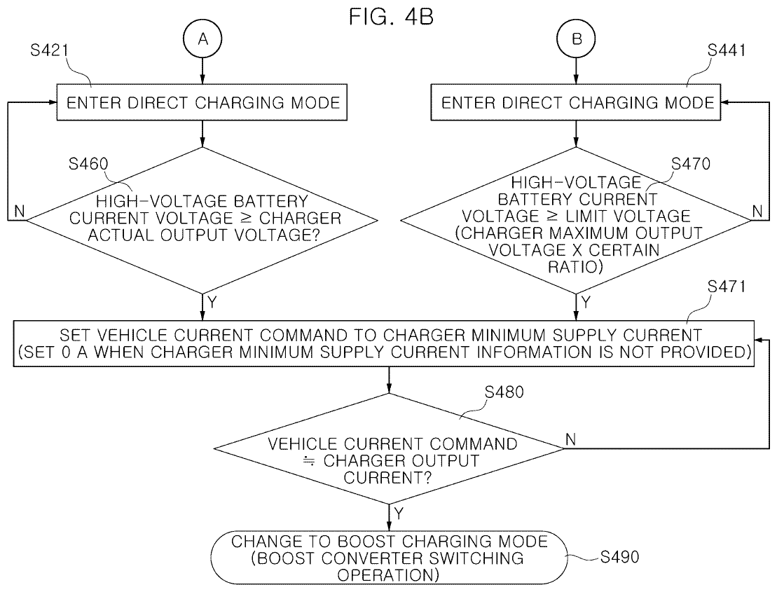

FIG. 5 is a conceptual diagram of switching between fast charging modes when the vehicle high-voltage battery maximum voltage<the charger maximum output voltage according to one embodiment of the present disclosure. Referring to FIG. 5, a straight line 510 of the high-voltage battery current voltage, a straight line 520 of the charger actual operating maximum voltage, a straight line 530 of the high-voltage battery maximum voltage, and a straight line 540 of the charger maximum operating voltage are sequentially illustrated from below.

The fast charging proceeds in the direct charge mode as the initial charging mode. In this section, the charging mode switching is not applied. Because the charger actual output voltage does not increase, the vehicle high-voltage battery current voltage and the charger output voltage are almost the same.

Accordingly, the vehicle current command transmitted from the vehicle 120 to the charger 110 is lowered to the charger minimum output current. Of course, when there is no minimum supply current information provided by the charger side, the vehicle current command is set to a preset current (for example, 0 A).

After confirming that the charger output current (that is, vehicle current command≈charger output current) has been lowered in accordance with the vehicle current command in the charger 110, the charge controller 210 changes the direct charging mode to the boost charging mode through an on/off operation of the switching element of the boost converter 220 or the drive block 230.

After changing to the boost charging mode, the vehicle current command lowered for changing the charging mode is raised back to the original value.

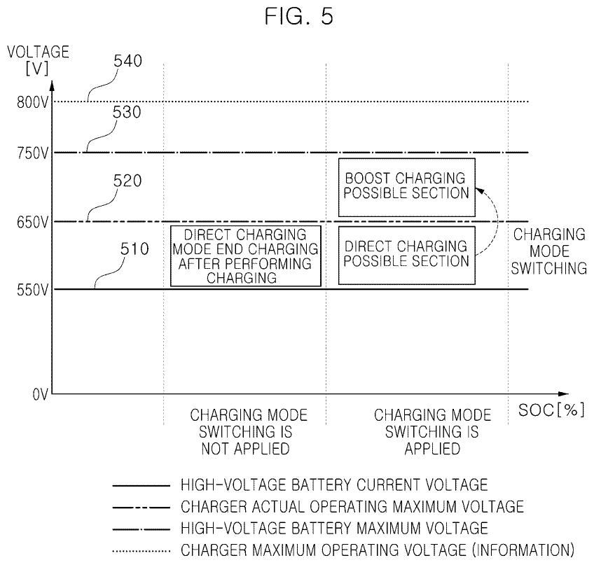

FIG. 6 is a conceptual diagram of switching between the fast charging modes when the vehicle high-voltage battery maximum voltage>the charger maximum output voltage according to one embodiment of the present disclosure. Referring to FIG. 6, a straight line 610 of the high-voltage battery current voltage, a straight line 620 of the charger maximum voltage, and a straight line 630 of the high-voltage battery maximum voltage are sequentially illustrated from below.

Referring to FIG. 6, when the vehicle high-voltage battery maximum voltage>the charger maximum output voltage, and the vehicle high-voltage battery current voltage>the charger maximum output voltage, the charge controller 210 enters the boost charging mode as a charging initial entry mode and maintains the boost charging mode until the charging ends. In this case, an on/off operation is performed for the switching element of the boost converter 220.

Meanwhile, when the vehicle high-voltage battery maximum voltage>the charger maximum output voltage, and the vehicle high-voltage battery current voltage<the charger maximum output voltage, the charge controller enters the direct charging mode as the charging initial entry mode. In this case, the switching element of the boost converter 220 or the drive block 230 remains in the off state.

In this state, when the battery 240 is charged and the high-voltage battery current voltage rises to the limit voltage (that is, the charger maximum output voltage x a certain ratio), preparation for changing from the direct charging mode to the boost charging mode is performed.

The charging current command transmitted from the vehicle 120 to the charger 110 is lowered to the charger minimum supply current. When there is no information on the minimum supply current provided by the charger side, 0 A is set.

After confirming that the charge controller 210 has lowered the charger output current in accordance with the vehicle current command from the charger 110, the charging mode is changed to the boost charging mode by performing an ON/OFF operation on the switching element of the boost converter 220 or the drive block 230.

After changing to the boost charging mode, the charge controller 210 raises the vehicle current command lowered for changing the charging mode to the original value again.

In order for the charger 110 to charge, the charger output voltage should be always be higher than the vehicle high-voltage battery voltage. When the battery 240 is charged, the current voltage increases, and when the voltage of the battery increases to near the charger maximum operating voltage and there is almost no voltage difference, the charger may not be able to charge. Therefore, instead of the actual charger maximum voltage, a certain percentage is applied to change the mode to the boost charging mode in a state lower than the maximum voltage.

FIG. 7 is a conceptual diagram of the boost charging according to one embodiment of the present disclosure. In particular, FIG. 7 is an equivalent circuit diagram of the boost converter 220. Referring to FIG. 7, when a switching element T_{R} is turned on, a charging voltage V₁ from the charger 110 is stored in an inductor L.

The switching element T_{R} may be a semiconductor switching element such as a Field Effect Transistor (FET), a Metal Oxide Semiconductor FET (MOSFET), an Insulated Gate Bipolar Mode Transistor (IGBT), and a power rectifier diode, a thyristor, a Gate Turn-Off (GTO) thyristor, a Triode for alternating current (TRIAC), a Silicon Controlled Rectifier (SCR), an Integrated Circuit (IC), or the like.

In particular, for the semiconductor device, a bipolar, a power Metal Oxide Silicon Field Effect Transistor (MOSFET) device, and the like may be used. The power MOSFET device has a Double-Diffused Metal Oxide Semiconductor (DMOS) structure, unlike a general MOSFET, due to high-voltage and high-current operation.

After energy is stored in the inductor L, when the switching element T_{R} is turned off again, the charging voltage is increased by the amount of energy stored in the inductor L to charge the battery 240. That is, the voltage V_{O} generated in both ends of the resistor R connected in parallel with the capacitor C is charged to the battery 240. A diode D may be configured between the switching element T_{R} and the capacitor C to prevent reverse current.

FIG. 8 is a conceptual diagram of the direct charging according to one embodiment of the present disclosure. Referring to FIG. 8, in the case of direct charging, the switching element T_{R} is kept in the off state so that the charging voltage V₁ generates the same voltage V_{O} in both ends of the resistor R and is supplied to the battery 240. That is, there is no boosting process through the inductor L.

In FIGS. 7 and 8, the boost converter 220 separately provided in the vehicle 120 is used as an example to explain the concepts of the boost charging and direct charging, but the drive block 230 including the motor 231 and the inverter 232 also has a similar equivalent circuit diagram. In other words, by connecting the charger 110 through the neutral terminal of the motor 231 and controlling the on/off of the inductor in the motor 231 and the switching element in the inverter 232, it can be operated like the boost converter.

Since the boosting technology using the motor and the inverter is disclosed in Korean Patent Publication No. 10-2023-0000334 applied by the same applicant, further description thereof will be omitted.

In addition, the steps of the method or algorithm described in connection with the embodiments disclosed herein may be implemented in the form of program instructions that can be executed by various computer means, such as a microprocessor, a processor, a CPU (Central Processing Unit), and the like, and recorded on a computer-readable medium. The computer-readable medium may include program (instruction) codes, data files, data structures, or the like, alone or in combination.

Although the present disclosure has been described above with reference to the exemplary drawings, the present disclosure is not limited to the described embodiments, and it is apparent to those skilled in the art that various modifications and changes can be made without departing from the spirit and scope of the present disclosure. Therefore, these modified examples or changed examples should be included in the claims of the present disclosure, and the scope of the present disclosure should be construed based on the appended claims.

What is claimed is:

1. A method for switching between fast charging modes, the method comprising:
exchanging information between a charger and a vehicle;
comparing a high-voltage battery maximum voltage and a charger maximum output voltage by a charge controller of the vehicle according to the exchange of the information;
comparing a high-voltage battery current voltage and the charger maximum output voltage by the charge controller when the high-voltage battery maximum voltage is greater than the charger maximum output voltage;
entering the charge controller into a boost charging mode when the high-voltage battery current voltage is greater than the charger maximum output voltage; and
entering the charge controller into a direct charging mode when the high-voltage battery current voltage is equal to or less than the charger maximum output voltage.

2. The method of claim 1, further comprising:
entering the charge controller into the direct charging mode to compare the high-voltage battery current voltage and a charger actual output voltage and maintain the direct charging mode or change the direct charging mode to the boost charging mode according to a result of the comparison when the high-voltage battery maximum voltage is equal to or less than the charger maximum output voltage.

3. The method of claim 2, wherein the changing includes changing the direct charging mode to the boost charging mode using a vehicle current command transmitted to the charger and a charger output current from the charger by the charge controller when the high-voltage battery current voltage is equal to or more than the charger actual output voltage.

4. The method of claim 3, wherein the changing of the direct charging mode to the boost charging mode includes:
setting the vehicle current command to a charger minimum supply current by the charge controller;
comparing whether the vehicle current command and the charger output current are the same by the charge controller; and
changing the direct charging mode to the boost charging mode when the vehicle current command and the charger output current are the same as a result of the comparison.

5. The method of claim 4, wherein the changing of the direct charging mode to the boost charging mode includes increasing the vehicle current command to an original value after the charge controller changes the direct charging mode to the boost charging mode.

6. The method of claim 3, wherein the vehicle current command is set to a preset current when information on a charger minimum supply current is not provided.

7. The method of claim 2, wherein the changing includes maintaining the direct charging mode by the charge controller when the high-voltage battery current voltage is smaller than the charger actual output voltage.

8. The method of claim 1, where the entering of the direct charging mode includes comparing the high-voltage battery current voltage and a pre-calculated limit voltage by the charge controller to maintain the direct charging mode or change the direct charging mode to the boost charging mode according to a result of the comparison.

9. The method of claim 8, wherein the changing includes changing the direct charging mode to the boost charging mode using a vehicle current command and a charger output current from the charger by the charge controller when the high-voltage battery current voltage is equal to or more than the pre-calculated limit voltage.

10. The method of claim 8, wherein the pre-calculated limit voltage is a product of the charger maximum output voltage and a certain ratio.

11. The method of claim 8, wherein the changing includes maintaining the direct charging mode by the charge controller when the high-voltage battery current voltage is smaller than the pre-calculated limit voltage.

12. The method of claim 1, wherein in the entering of the boost charging mode in a state where the high-voltage battery current voltage is greater than the charger maximum output voltage, the boost charging mode is maintained until the charging ends.

13. The method of claim 1, wherein the boost charging mode is executed using a separate boost converter installed in the vehicle or a drive block including a motor and inverter in the vehicle.

14. The method of claim 1, wherein in the entering of the direct charging mode, a charging initial entry mode is the direct charging mode.

15. A system for switching between fast charging modes, the system comprising:
one or more processors; and
one or more memory devices storing programming code comprising instructions which, when executed by the one or more processors, cause the one or more processors to:
exchange information between a charger and a vehicle;
perform, by a charge controller of the vehicle and based on the exchanged information, a first comparison between a high-voltage battery maximum voltage and a charger maximum output voltage;
perform, by the charge controller, a second comparison between a high-voltage battery current voltage and the charger maximum output voltage when the high-voltage battery maximum voltage is greater than the charger maximum output voltage;
enter the charge controller into a boost charging mode when the high-voltage battery current voltage is greater than the charger maximum output voltage; and
enter the charge controller into a direct charging mode when the high-voltage battery current voltage is equal to or less than the charger maximum output voltage.

16. The system of claim 15, wherein the execution of the instructions by the one or more processors further cause the one or more processors to:
enter the charge controller into the direct charging mode;
perform a third comparison between the high-voltage battery current voltage and a charger actual output voltage; and
maintain the direct charging mode or change the direct charging mode to the boost charging mode according to a result of the third comparison when the high-voltage battery maximum voltage is equal to or less than the charger maximum output voltage.

17. The system of claim 16, wherein, to change the direct charging mode to the boost charging mode, execution of the instructions by the one or more processors further cause the one or more processors to:
use, by the charge controller, a vehicle current command transmitted to the charger and a charger output current from the charger when the high-voltage battery current voltage is equal to or more than the charger actual output voltage.

18. A non-transitory computer-readable medium comprising instructions which, when executed by one or more processors, cause the one or more processors to:
exchange information between a charger and a vehicle comprising the one or more processors;
perform, by a charge controller executing on the one or more processors of the vehicle and based on the exchanged information, a first comparison between a high-voltage battery maximum voltage and a charger maximum output voltage;
perform, by the charge controller, a second comparison between a high-voltage battery current voltage and the charger maximum output voltage when the high-voltage battery maximum voltage is greater than the charger maximum output voltage;
enter the charge controller into a boost charging mode when the high-voltage battery current voltage is greater than the charger maximum output voltage; and
enter the charge controller into a direct charging mode when the high-voltage battery current voltage is equal to or less than the charger maximum output voltage.

19. The non-transitory computer-readable medium of claim 18, wherein, to enter the direct charging mode, the execution of the instructions by the one or more processors further cause the one or more processors to:
perform, by the charge controller, a third comparison between the high-voltage battery current voltage and a pre-calculated limit voltage; and
maintain the direct charging mode or change the direct charging mode to the boost charging mode according to a result of the third comparison.

20. The non-transitory computer-readable medium of claim 19, wherein, to change the direct charging mode to the boost charging mode, the execution of the instructions by the one or more processors further cause the one or more processors to:
use, by the charge controller, a vehicle current command and a charger output current from the charger when the high-voltage battery current voltage is equal to or more than the pre-calculated limit voltage.
